(19) United States
(12) Patent Application Publication
(10) Pub. No.: US 2006/0050024 A1
(43) Pub. Date: Mar. 9, 2006

(54) Plasma display apparatus and driving method thereof

(76) Inventor: Oe Dong Kim, Seongnam-si (KR)

Correspondence Address: MCKENNA LONG & ALDRIDGE LLP;Song K. Jung, 1900 K Street, N.W., Washington, DC, 20006, US

(21) Appl. No.: 11/218,566

(22) Filed: Sep. 6, 2005

(30) Foreign Application Priority Data
Sep. 6, 2004 (KR) 10-2004-0071008
Sep. 7, 2004 (KR) 10-2004-0071465
Sep. 7, 2004 (KR) 10-2004-0071467

(51) Int. Cl. G09G 3/28

(52) U.S. Cl. 345/67

(57) ABSTRACT

Disclosed are a plasma display apparatus and a driving method thereof. The plasma display apparatus includes a PDP on which scan electrodes and sustain electrodes have been formed, a scan driving unit for sequentially supplying a first up ramp waveform, a first down ramp waveform and a second down ramp waveform to the scan electrodes in a reset period of a first sub-field of a plurality of sub-fields, and a sustain driving unit for supplying a square wave to the sustain electrodes while the first down ramp waveform is supplied to the scan electrodes, and supplying a third down ramp waveform falling from the minimum voltage of the square wave to the sustain electrodes while the second down ramp waveform is supplied to the scan electrodes.

### CROSS-REFERENCE TO RELATED APPLICATIONS

This application claims benefit under 35 U.S.C. § 119 from Korean Patent Application No. 2004-0071008, 2004-0071465 & 2004-0071467 filed on Sep. 6 & 7, 2005, the entire content of which is incorporated herein by reference.

### BACKGROUND OF THE INVENTION

1. Field of the Invention

The present invention relates to a plasma display apparatus and a driving method thereof.

2. Description of the Related Art

In general, a plasma display panel (hereinafter, referred to as ‘PDP’) displays images including characters or graphics, by making phosphors emit light by 147 nm of ultraviolet rays generated by He+Xe or Ne+Xe gas discharge.

FIG. 1 is a perspective diagram illustrating a conventional 3-electrode AC surface-discharge PDP. Referring to FIG. 1, the 3-electrode AC surface-discharge PDP includes scan electrodes 11 (hereinafter, referred to as ‘Y electrodes’) and sustain electrodes 12 (hereinafter, referred to as ‘Z electrodes’) formed on a top substrate 10, and address electrodes 22 (hereinafter, referred to as ‘X electrodes’) formed on a bottom substrate 20. Each of the Y electrodes 11 and the Z electrodes 12 includes a transparent electrode, for example, Indium-Tin-Oxide (ITO) 11a and 12a. Bus electrodes 11b and 12b for reducing resistance are formed on the Y electrodes 11 and the Z electrodes 12, respectively. A top dielectric layer 13a and a protective film 14 are stacked on the top substrate 10 on which the Y electrodes 11 and the Z electrodes 12 have been formed. Wall charges generated in plasma discharge are accumulated on the top dielectric layer 13a. The protective film 14 protects the top dielectric layer 13a from sputtering generated in plasma discharge, and improves discharge efficiency of secondary electrons. Generally, the protective film 14 is made of MgO.

On the other hand, a bottom dielectric layer 13b and a barrier rib 21 are formed on the bottom substrate 20 on which the X electrodes 22 have been formed. A phosphor layer 23 is coated on the surfaces of the bottom dielectric layer 13a and the barrier rib 21. The X electrodes 22 are formed to cross the Y electrodes 11 and the Z electrodes 12. The barrier rib 21 and the X electrodes 22 are formed side by side, for preventing ultraviolet rays and visible rays generated by discharge from being leaked to the adjacent discharge cells. The phosphor layer 23 is excited by ultraviolet rays generated by plasma discharge, for generating any one of R, G and B visible rays. Inert mixed gases for discharge such as He+Xe or Ne+Xe are injected into the discharge spaces of the discharge cells formed between the top and bottom substrates 10 and 20 and the barrier rib 21. The driving waveforms by the conventional driving method of the PDP will now be explained with reference to FIG. 2.

FIG. 2 is a waveform diagram showing the driving waveforms by the conventional driving method of the PDP. As illustrated in FIG. 2, the PDP is driven in a reset period for resetting the whole screen, an address period for selecting the discharge cell, a sustain period for maintaining discharge of the selected cell, and an erase period for erasing wall charges of the discharged cell.

In the set-up period of the reset period, an up ramp waveform Ramp-up is applied to all the scan electrodes Y at the same time. The discharge operation is performed in the cells of the whole screen by the up ramp waveform Ramp-up. The set-up discharge accumulates positive polarity wall charges on the address electrodes X and the sustain electrodes Z and negative wall charges on the scan electrodes Y. In the set-down period, after the up ramp waveform Ramp-up is supplied, a down ramp waveform Ramp-down falling from a positive polarity voltage lower than a peak voltage of the up ramp waveform Ramp-up to a specific voltage level below a ground level voltage GND causes slight erase discharge to the cells, thereby sufficiently erasing the excessively-generated wall charges. The wall charges for stably performing the address discharge are evenly left in the cells by the set-down discharge.

In the address period, a negative polarity scan pulse Scan is sequentially applied to the scan electrodes Y, and a positive polarity data pulse data is synchronized with the scan pulse Scan and applied to the address electrodes X at the same time. As the voltage difference between the scan pulse Scan and the data pulse data and the wall voltage generated in the reset period are added, the address discharge occurs in the cells to which the data pulse data is applied. Wall charges for generating discharge by application of a sustain voltage Vs are formed in the cells selected by the address discharge. A positive polarity voltage Vz is supplied to the sustain electrodes Z during the set-down period and the address period to prevent mis-discharge between the sustain electrodes Z and the scan electrodes Y by reducing the voltage difference between the sustain electrodes Z and the scan electrodes Y.

In the sustain period, a sustain pulse Sus is alternately applied to the scan electrodes Y and the sustain electrodes Z. In the cell selected by the address discharge, as the wall voltage of the cell and the sustain pulse Sus are added, sustain discharge, namely, display discharge occurs between the scan electrodes Y and the sustain electrodes Z in every application of the sustain pulse Sus.

After the sustain discharge is completed, in the erase period, an erase ramp waveform voltage Ramp-ers having a small pulse width and a low voltage level is supplied to the sustain electrodes Z, thereby erasing the wall charges left in the cells of the whole screen.

The conventional driving method of the PDP using the driving waveforms deteriorates a contrast ratio of the panel due to relatively high dark luminance in driving.

In addition, a ratio of Xe in the discharge cells has recently increased to improve discharge efficiency of the PDP. In this case, when the driving waveforms by the conventional driving method of the PDP are applied, the address electrodes X interferes with the discharge between the scan electrodes Y and the sustain electrodes Z, thereby raising the reset voltage in discharge. As a result, when the driving waveforms are applied to the large screen, the driving margin of the panel is reduced.

Furthermore, when the ratio of Xe more increases in the discharge cells, address jitter characteristics are deteriorated to destabilize the sustain discharge in the succeeding sustain period.

### SUMMARY OF THE INVENTION

Accordingly, an object of the present invention is to provide a plasma display apparatus which can obtain a driving margin of a panel and improve contrast characteristics by restricting rise of a reset voltage in discharge, although a ratio of Xe charged in discharge cells increases, and a driving method thereof.

Another object of the present invention is to provide a plasma display apparatus which can stably perform sustain discharge in a sustain period by preventing address jitter characteristics from being deteriorated by increase of a ratio of Xe, and a driving method thereof.

In order to achieve the above-described objects of the invention, there is provided a plasma display apparatus, including: a PDP on which scan electrodes and sustain electrodes have been formed; a scan driving unit for sequentially supplying a first up ramp waveform, a first down ramp waveform and a second down ramp waveform to the scan electrodes in a reset period of a first sub-field of a plurality of sub-fields; and a sustain driving unit for supplying a square wave to the sustain electrodes while the first down ramp waveform is supplied to the scan electrodes, and supplying a third down ramp waveform falling from the minimum voltage of the square wave to the sustain electrodes while the second down ramp waveform is supplied to the scan electrodes.

According to another aspect of the present invention, there is provided a plasma display apparatus, including: a PDP on which scan electrodes and sustain electrodes have been formed; a scan driving unit for sequentially supplying a first up ramp waveform and a first down ramp waveform to the scan electrodes in a reset period of a first sub-field of a plurality of sub-fields; and a sustain driving unit for supplying a second down ramp waveform being maintained at a predetermined voltage and falling from the voltage to the sustain electrodes while the first down ramp waveform is supplied to the scan electrodes.

According to yet another aspect of the present invention, there is provided a driving method of a plasma display apparatus, which divides a plurality of sub-fields having a different light emission number into a reset period, an address period and a sustain period, displays an image by applying a predetermined signal to scan electrodes, sustain electrodes and address electrodes in each period, supplies one or more down ramp waveforms to the scan electrodes in the reset period of the first sub-field of the plurality of sub-fields, and supplies a waveform being maintained at a first voltage and falling to a second voltage to the sustain electrodes while the down ramp waveform is supplied to the scan electrodes.

The present invention can improve jitter characteristics by address discharge by erasing wall charges of the address electrodes in the reset period of the sub-field.

In addition, the present invention can obtain a high driving margin by stabilizing address discharge and stably performing sustain discharge in the succeeding sustain period.

Furthermore, the present invention can improve contrast characteristics by reduction of dark luminance, by supplying an up ramp waveform having a low voltage or not supplying the up ramp waveform in the reset period of the sub-fields except the first sub-field.

### BRIEF DESCRIPTION OF THE DRAWINGS

The above aspects and features of the present invention will be more apparent by describing certain embodiments of the present invention with reference to the accompanying drawings, in which:

FIG. 1 is a perspective diagram illustrating a conventional 3-electrode AC surface-discharge PDP.

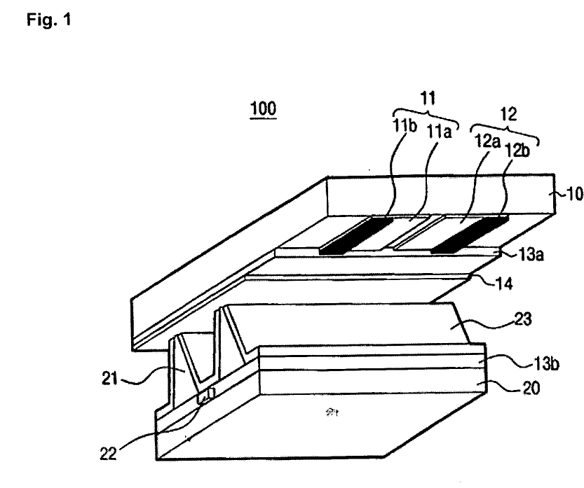

FIG. 2 is a waveform diagram showing driving waveforms by a conventional driving method of the PDP.

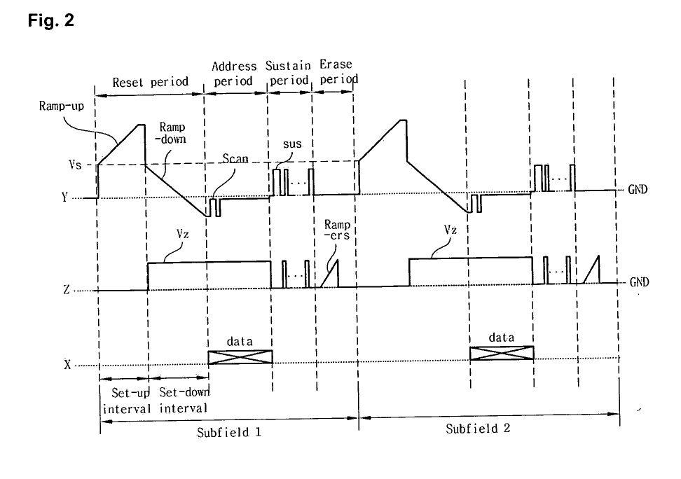

FIG. 3 is a schematic block diagram illustrating a plasma display apparatus in accordance with the present invention.

FIG. 4 is a waveform diagram showing first driving waveforms by a driving method of the plasma display apparatus in accordance with the present invention.

FIG. 5 is a waveform diagram showing wall voltage variation and dark luminance by surface discharge and facing discharge in a reset period by the first driving waveforms of the plasma display apparatus in accordance with the present invention.

FIG. 6 is a comparative diagram showing a wall voltage state of the cell after reset discharge by the first driving waveforms of the plasma display apparatus of the present invention and a wall voltage state of the cell after reset discharge by the general driving waveforms.

FIG. 7 is a waveform diagram showing second driving waveforms by the driving method of the plasma display apparatus in accordance with the present invention.

FIG. 8 is a waveform diagram showing third driving waveforms by the driving method of the plasma display apparatus in accordance with the present invention.

FIG. 9 is a waveform diagram showing fourth driving waveforms by the driving method of the plasma display apparatus in accordance with the present invention.

### DETAILED DESCRIPTION OF THE PREFERRED EMBODIMENTS

Preferred embodiments of the present invention will be described in a more detailed manner with reference to the drawings.

The plasma display apparatus includes a PDP on which scan electrodes and sustain electrodes have been formed, a scan driving unit for sequentially supplying a first up ramp waveform, a first down ramp waveform and a second down ramp waveform to the scan electrodes in a reset period of a first sub-field of a plurality of sub-fields, and a sustain driving unit for supplying a square wave to the sustain electrodes while the first down ramp waveform is supplied to the scan electrodes, and supplying a third down ramp waveform falling from the minimum voltage of the square wave to the sustain electrodes while the second down ramp waveform is supplied to the scan electrodes.

The lowest voltages of the first down ramp waveform and the second down ramp waveform are negative voltages.

The lowest voltage of the second down ramp waveform is lower than that of the first down ramp waveform.

The maximum voltage of the square wave is a voltage of a sustain pulse applied in a sustain period.

The lowest voltage of the third down ramp waveform is a negative voltage.

The scan driving unit supplies a fourth down ramp waveform being maintained at a predetermined voltage and falling from the voltage to the scan electrodes in the reset period of the plurality of sub-fields except the first sub-field. The sustain driving unit supplies a second up ramp waveform to the sustain electrodes while the scan electrodes are maintained at a predetermined voltage, and supplies a fifth down ramp waveform to the sustain electrodes while the fourth down ramp waveform is supplied to the scan electrodes.

The predetermined voltage is a ground level voltage.

The highest voltage of the second up ramp waveform is a sustain voltage.

The lowest voltage of the fourth down ramp waveform is identical to the lowest voltage of the second down ramp waveform.

The lowest voltage of the fifth down ramp waveform is a negative voltage.

The scan driving unit sequentially supplies a fourth down ramp waveform and a fifth down ramp waveform to the scan electrodes in the reset period of the plurality of sub-fields except the first sub-field. The sustain driving unit supplies a square wave to the sustain electrodes while the fourth down ramp waveform is supplied to the scan electrodes, and supplies a sixth down ramp waveform falling from the minimum voltage of the square wave to the sustain electrodes while the fifth down ramp waveform is supplied to the scan electrodes.

The lowest voltage of the fourth down ramp waveform is identical to the lowest voltage of the first down ramp waveform, and the lowest voltage of the fifth down ramp waveform is identical to the lowest voltage of the second down ramp waveform.

The maximum voltage of the square wave is a voltage of a sustain pulse applied in a sustain period.

The lowest voltage of the sixth down ramp waveform is identical to the lowest voltage of the third down ramp waveform.

According to another aspect of the present invention, a plasma display apparatus includes a PDP on which scan electrodes and sustain electrodes have been formed, a scan driving unit for sequentially supplying a first up ramp waveform and a first down ramp waveform to the scan electrodes in a reset period of a first sub-field of a plurality of sub-fields, and a sustain driving unit for supplying a second down ramp waveform being maintained at a predetermined voltage and falling from the voltage to the sustain electrodes while the first down ramp waveform is supplied to the scan electrodes.

The lowest voltage of the second down ramp waveform has a ground level.

The scan driving unit sequentially supplies a second up ramp waveform and a third down ramp waveform smaller than the first up ramp waveform to the scan electrodes in the reset period of the plurality of sub-fields except the first sub-field. The sustain driving unit supplies a fourth down ramp waveform being maintained at a predetermined voltage and falling from the voltage to the sustain electrodes while the third down ramp waveform is supplied to the scan electrodes.

The third down ramp waveform falls from a ground level.

The third down ramp waveform falls from the highest voltage of the second up ramp waveform.

In accordance with the present invention, a driving method of a plasma display apparatus divides a plurality of sub-fields having a different light emission number into a reset period, an address period and a sustain period, displays an image by applying a predetermined signal to scan electrodes, sustain electrodes and address electrodes in each period, supplies one or more down ramp waveforms to the scan electrodes in the reset period of the first sub-field of the plurality of sub-fields, and supplies a waveform being maintained at a first voltage and falling to a second voltage to the sustain electrodes while the down ramp waveform is supplied to the scan electrodes.

The plasma display apparatus and the driving method thereof in accordance with the preferred embodiments of the present invention will now be described in detail with reference to the accompanying drawings.

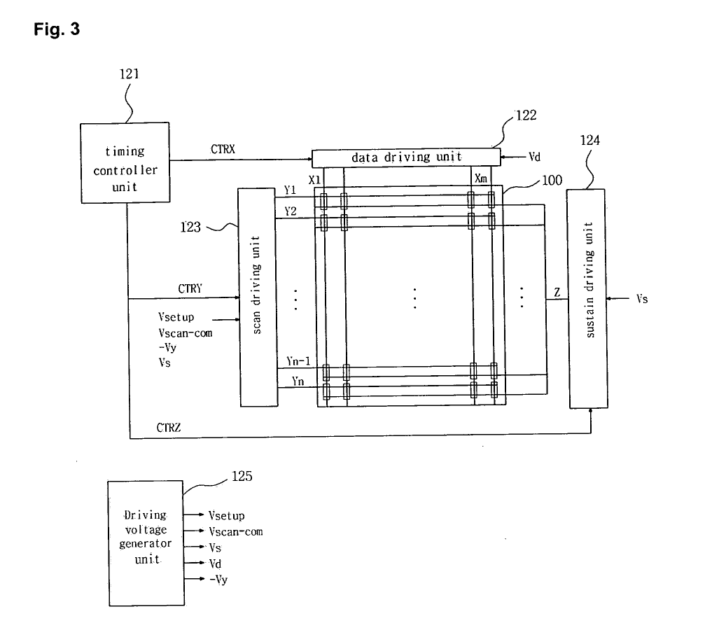

FIG. 3 is a schematic block diagram illustrating the plasma display apparatus in accordance with the present invention.

Referring to FIG. 3, the plasma display apparatus includes a PDP 100, a data driving unit 122 for supplying data to address electrodes X1 to Xm formed on a bottom substrate (not shown) of the PDP, a scan driving unit 123 for driving scan electrodes Y1 to Yn, a sustain driving unit 124 for driving sustain electrodes Z that are common electrodes, a timing control unit 121 for controlling the data driving unit 122, the scan driving unit 123 and the sustain driving unit 124 in driving the PDP 100, and a driving voltage generating unit 125 for supplying a driving voltage to each driving unit 122, 123 and 124.

The PDP 100 is formed by soldering the top substrate (not shown) and the bottom substrate (not shown) with a predetermined gap. A plurality of electrodes, for example, the scan electrodes Y1 to Yn and the sustain electrodes Z are formed on the top substrate in pairs, and the address electrodes X1 to Xm are formed on the bottom substrate to cross the scan electrodes Y1 to Yn and the sustain electrodes Z.

The data being inverted gamma-corrected and error-diffused by an inverted gamma correction circuit (not shown) and an error diffusion circuit (not shown) and mapping in each sub-field by a sub-field mapping circuit are supplied to the data driving unit 122. The data driving unit 122 samples and latches the data in response to a timing control signal CTRX from the timing control unit 121, and supplies the data to the address electrodes X1 to Xm.

The scan driving unit 123 supplies a first up ramp waveform Ramp-up in a reset period of a first sub-field of a plurality of sub-fields under the control of the timing control unit 121, and sequentially supplies a first down ramp waveform Ramp-down and a second down ramp waveform Ramp-down to the scan electrodes Y1 to Yn. Here, the first down ramp waveform Ramp-down and the second down ramp waveform Ramp-down can be consecutively supplied to the scan electrodes Y1 to Yn as one down ramp waveform. In addition, the scan driving unit 123 sequentially supplies a scan pulse Sp of a scan voltage −Vy to the scan electrodes Y1 to Yn in an address period under the control of the timing control unit 121, and supplies a sustain pulse generated by a built-in energy recovering circuit to the scan electrodes Y1 to Yn in a sustain period.

The sustain driving unit 124 supplies a square wave to the sustain electrodes Z while the scan driving unit 123 supplies the first down ramp waveform Ramp-down to the scan electrodes Y1 to Yn in the reset period of the first sub-field of the plurality of sub-fields under the control of the timing control unit 121. Also, the sustain driving unit 124 supplies a third down ramp waveform to the sustain electrodes Z while the scan driving unit 123 supplies the second down ramp waveform Ramp-down to the scan electrodes Y1 to Yn. Here, the third down ramp waveform falls from the minimum voltage of the square wave to a predetermined voltage. In the case that the first down ramp waveform and the second down ramp waveform are consecutively supplied to the scan electrodes Y1 to Yn as one down ramp waveform in the reset period of the first sub-field of the plurality of sub-fields, the sustain driving unit 124 can supply a ramp waveform being maintained at a predetermined voltage and falling from the voltage to the sustain electrodes Z while the down ramp waveform is supplied to the scan electrodes Y1 to Yn.

The sustain driving unit 124 supplies a predetermined bias voltage to the sustain electrodes Z in the address period. A sustain driving circuit of the sustain driving unit 124 and a sustain driving circuit of the scan driving unit 123 are alternately operated in the sustain period, for supplying a sustain pulse sus to the sustain electrodes Z.

The first sub-field can be any one of the plurality of sub-fields, preferably, a sub-field having the lowest gray level weight.

The timing control unit 121 receives a vertical/horizontal synchronization signal and a clock signal, generates timing control signals CTRX, CTRY and CTRZ for controlling operational timing and synchronization of each driving unit 122, 123 and 124 in the reset period, the address period and the sustain period, and supplies the timing control signals CTRX, CTRY and CTRZ to each driving unit 122, 123 and 124, thereby controlling each driving unit 122, 123 and 124.

The data control signal CTRX includes a sampling clock for sampling data, a latch control signal, and a switch control signal for controlling an on/off time of the sustain driving circuit and driving switch elements. The scan control signal CTRY includes a switch control signal for controlling an on/off time of the sustain driving circuit and driving switch elements of the scan driving unit 123. The sustain control signal CTRZ includes a switch control signal for controlling an on/off time of the sustain driving circuit and driving switch elements of the sustain driving unit 124.

The driving voltage generating unit 125 generates a set-up voltage Vsetup, a scan common voltage Vscan-com, a scan voltage −Vy, a sustain voltage Vs and a data voltage Vd. Such driving voltages can be varied by a composition of discharge gas or a structure of discharge cells.

On the other hand, the operation of supplying predetermined waveforms by the scan driving unit and the sustain driving unit of the plasma display apparatus in the reset period of the first sub-field of the plurality of sub-fields has been explained. The other sub-fields can be supplied with various types of waveforms according to characteristics of the PDP, for example, discharge characteristics by an amount of inert gas of the PDP, which will be explained in detail with the driving method of the plasma display apparatus.

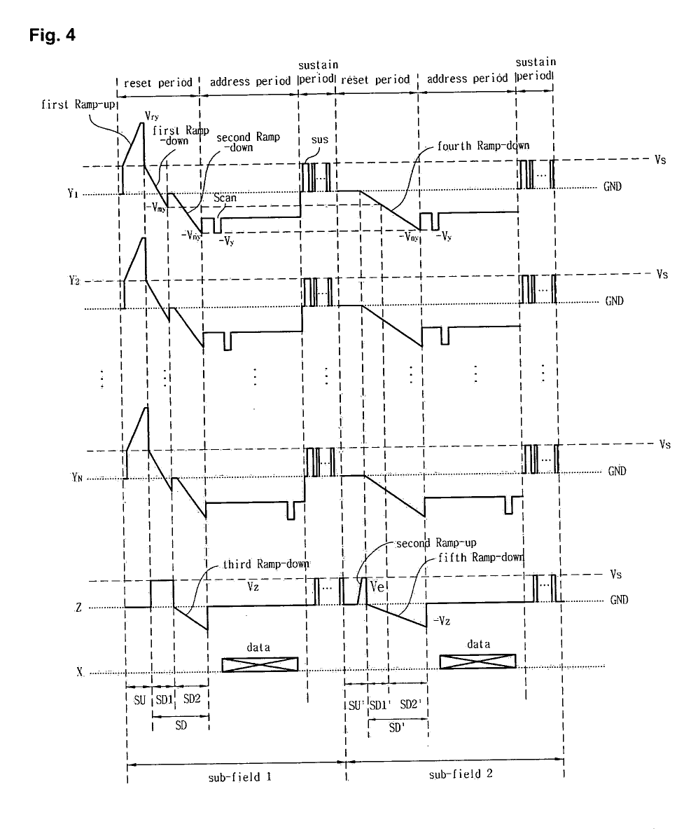

FIG. 4 is a waveform diagram showing first driving waveforms by the driving method of the plasma display apparatus in accordance with the present invention.

In the driving method of the plasma display apparatus, the plurality of sub-fields can be supplied with predetermined driving waveforms in the reset period for resetting the whole screen, the address period for selecting the discharge cell, and the sustain period for maintaining discharge of the selected cell.

As shown in FIG. 4, in the case of the first driving waveforms of the plasma display apparatus, different reset waveforms are supplied in the reset periods of the first sub-field and the other sub-fields.

First Sub-Field

When the plasma display apparatus is driven, a first up ramp waveform Ramp-up is simultaneously applied to all the scan electrodes Y1 to Yn in the set-up period SU of the reset period of the first sub-field, and a ground level voltage GND is applied to the sustain electrodes Z and maintained during the set-up period SU. Here, surface discharge is generated between the scan electrodes Y1 to Yn and the sustain electrodes Z in the cells of the whole screen by the first up ramp waveform.

The set-down period SD is divided into a first set-down period SD1 and a second set-down period SD2. A first down ramp waveform is supplied to all the scan electrodes Y1 to Yn in the first set-down period SD1, and a second down ramp waveform is supplied to all the scan electrodes Y1 to Yn in the second set-down period SD2. While the first down ramp waveform is supplied to the scan electrodes Y1 to Yn, a predetermined voltage of square wave is supplied to the sustain electrodes Z, and while the second down ramp waveform is supplied to the scan electrodes Y1 to Yn, a third down ramp waveform is supplied to the sustain electrodes Z.

The first down ramp waveform falls from a positive polarity voltage lower than a peak voltage Vry of the first up ramp waveform to a specific voltage level −Vmy below the ground level GND. Preferably, the lowest voltage that is the specific voltage level −Vmy of the first down ramp has a negative voltage value so that surface discharge can be sufficiently generated between the scan electrodes Y1 to Yn and the sustain electrodes Z. In addition, a predetermined voltage is applied to the sustain electrodes Z and maintained during the first set-down period SD1 in which the first down ramp voltage is supplied, and thus slight surface discharge occurs between the scan electrodes Y1 to Yn and the sustain electrodes Z. Accordingly, wall charges excessively formed in the cell are partially erased. Preferably, the predetermined voltage applied to the sustain electrodes Z is the sustain voltage Vs for generating surface discharge with a sufficient potential difference between the scan electrodes Y1 to Yn and the sustain electrodes Z.

The second down ramp waveform sharply rises from the end of the first down ramp waveform, namely, the specific voltage level −Vmy to the ground level GNb, maintains the ground level GND for a predetermined time, and falls to a voltage −Vny smaller than the specific voltage −Vmy below the ground level GND. Preferably, the lowest voltage that is the voltage −Vny of the second down ramp has a negative voltage value lower than the lowest value of the first down ramp supplied in surface discharge in order to sufficiently generate facing discharge between the scan electrodes Y1 to Yn and the address electrodes X1 to Xm and completely erase the wall charges. Here, the third down ramp waveform falling to the negative voltage below the ground level voltage GND is supplied to the sustain electrodes Z.

Therefore, the wall charges are evenly distributed in the discharge cell, so that address discharge can be stably performed in the succeeding address period.

On the other hand, the second down ramp waveform applied to the scan electrodes Y1 to Yn is sharply increased to the ground level GND at the end point of the first down ramp waveform in order to prevent instantaneous drop of the scan electrode voltage by coupling of the scan electrodes Y1 to Yn and the sustain electrodes Z when the voltage applied to the sustain electrodes Z is sharply dropped and the voltage applied to the scan electrodes Y1 to Yn is continuously dropped.

The Sub-Fields Except the First Sub-Field

When the plasma display apparatus is driven, the driving waveforms supplied in the reset period of the sub-fields except the first sub-field will now be explained with reference to FIG. 4. In the set-up period SU′, a ground level voltage GND is supplied to and maintained in all the scan electrodes Y1 to Yn, and a second up ramp waveform having a smaller voltage size than the first up ramp waveform supplied in the reset period of the first sub-field is applied to the sustain electrodes Z. Here, the cells which do not participate in the discharge during the sustain period of the first sub-field are maintained as they are. In the case of the cells participating in the discharge during the sustain period of the first sub-field, surface discharge occurs between the scan electrodes Y1 to Yn and the sustain electrodes Z by the second up ramp-waveform, thereby partially erasing the wall charges between the scan electrodes Y1 to Yn and the sustain electrodes Z.

A voltage Ve of the second up ramp waveform is a voltage for generating surface discharge between the scan electrodes Y1 to Yn and the sustain electrodes Z, preferably, the sustain voltage Vs, to use the voltage source of the sustain discharge.

As in the first sub-field, the set-down period SD′ is divided into a first set-down period SD1′ and a second set-down period SD2′. A fourth down ramp waveform is consecutively supplied to all the scan electrodes Y1 to Yn in the first set-down period SD1′ and the second set-down period SD2′, and a fifth down ramp waveform is consecutively supplied to the sustain electrodes Z in the first set-down period SD1′ and the second set-down period SD2′. Here, the fourth down ramp waveform falls from a ground level GND to a specific voltage level −Vny below the ground level GND. Preferably, the lowest voltage that is the specific voltage level −Vny of the fourth down ramp is a negative voltage for erasing wall charges by generating sufficient facing discharge between the scan electrodes Y1 to Yn and the address electrodes X1 to Xm. That is, the negative voltage is identical to the negative voltage of the second down ramp in the first sub-field. In addition, the lowest voltage of the fifth down ramp waveform is a negative voltage for erasing wall charges by generating sufficient facing discharge between the sustain electrodes Z and the address electrodes X1 to Xm, preferably, a voltage lower than the lowest voltage of the fourth down ramp waveform.

As described above, when the plasma display apparatus is driven, since the predetermined reset driving waveforms are supplied in the reset period of all sub-fields, the wall charges accumulated on each electrode are uniformed and the discharge operation is stably performed in the succeeding address period.

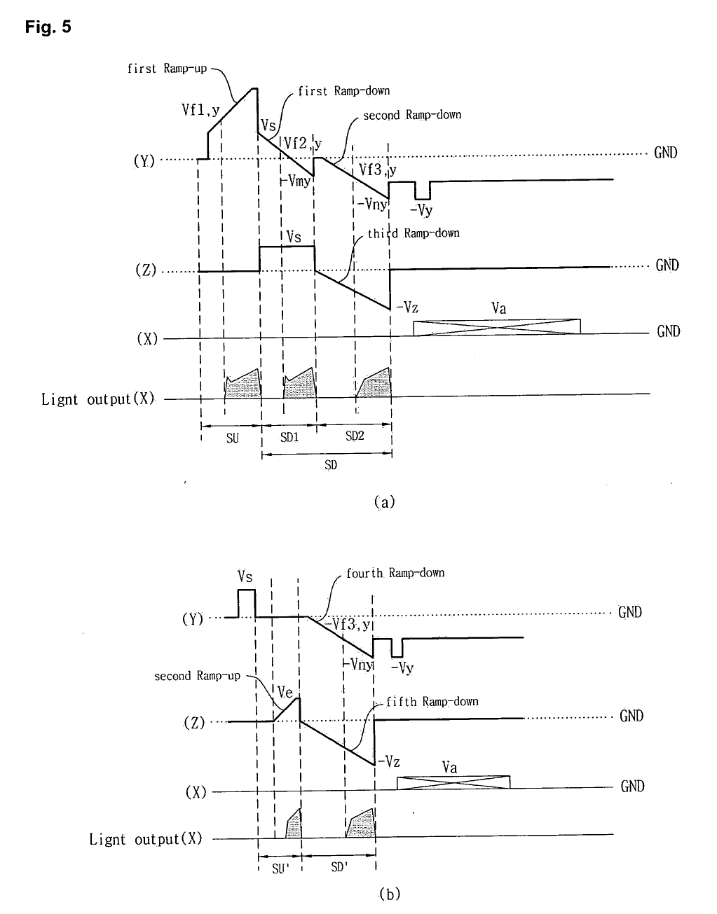

On the other hand, in the first driving method of the plasma display apparatus, wall voltage variation and dark luminance in the reset period will now be explained with reference to FIG. 5.

FIG. 5 is a waveform diagram showing wall voltage variation and dark luminance by surface discharge and facing discharge in the reset period by the first driving waveforms of the plasma display apparatus in accordance with the present invention. FIG. 5(a) shows wall voltage variation and dark luminance in the reset period of the first sub-field, and FIG. 5(b) shows wall voltage variation and dark luminance in the reset period of the other sub-fields.

First, wall voltage variation by surface discharge in the set-up period SU of the reset period of the first sub-field will now be explained with reference to FIG. 5(a). In the set-up period SU of the reset period of the first sub-field, the surface discharge is generated over a voltage Vf1,y between the scan electrodes Y1 to Yn and the sustain electrodes Z, thereby accumulating the wall voltage. Here, the wall voltage variation |ΔVw1,yz| is the difference between the highest voltage Vry of the first up ramp and the first surface discharge start voltage Vfl,y.

In the set-down period SD of the reset period of the first sub-field, the wall voltage variation by surface discharge and facing discharge is divided into two steps SD1 and SD2. In the first set-down period SD1, the surface discharge is generated below a voltage Vf2,y between the scan electrodes Y1 to Yn and the sustain electrodes Z, thereby partially erasing wall charges. Here, the wall voltage variation |ΔVw2,yz| is the difference between the surface discharge start voltage Vf2,y and the lowest voltage −Vmy of the first down ramp.

In the second set-down period SD2, the facing discharge is generated below a voltage −Vf3,y between the scan electrodes Y1 to Yn and the address electrodes X1 to Xm, thereby mostly erasing wall charges. Here, the wall voltage variation |ΔVw3,yx| is the difference between the facing discharge start voltage −Vf3,y and the lowest voltage −Vny of the second down ramp.

When the wall voltage varied by surface discharge and facing discharge in the reset period of the first sub-field satisfies the following formula (1), the reset period operation is stabilized to obtain a high driving margin.
|ΔVw2,yz|+0.5|ΔVw3,yx|<|ΔVw1,yz| Formula (1)

The wall voltage variation by surface discharge in the set-up period SU′ of the reset period of the other sub-fields will now be explained with reference to FIG. 5(b). In the set-up period SU′ of the reset period of the first sub-field, when the voltage Ve of the second up ramp is supplied, the surface discharge occurs over a predetermined voltage between the Y electrodes and the Z electrodes, thereby partially erasing wall charges. Thereafter, when the voltage falls to the lowest voltage −Vny of the fourth down ramp, the facing discharge occurs between the scan electrodes Y1 to Yn and the sustain electrodes Z, thereby mostly erasing wall charges. Here, the wall voltage variation |ΔVw3,yx| is identical to the difference between the facing discharge start voltage −Vf3,y and the lowest voltage −Vny of the second down ramp in the first sub-field.

On the other hand, as shown in FIG. 5(b), dark luminance generated in the reset period of the other sub-fields is smaller than dark luminance generated when the high voltage up ramp waveform is supplied in the first sub-field. That is, when the PDP is driven, the contrast characteristics are remarkably improved due to small dark luminance.

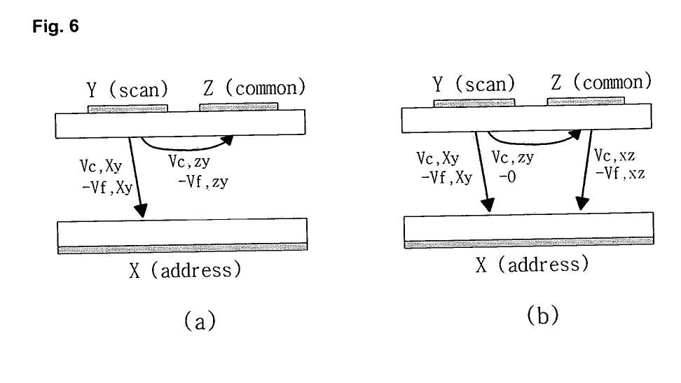

FIG. 6 is a comparative diagram showing the wall voltage state of the cell after reset discharge by the first driving waveforms of the plasma display apparatus of the present invention and the wall voltage state of the cell after reset discharge by the general driving waveforms. Referring to FIG. 6, after the reset discharge by the general driving waveforms (a), the cell voltage Vc,zy between the Y electrodes and the Z electrodes satisfies the sustain surface discharge voltage Vf,zy, and the cell voltage Vc,xy between the Y electrodes and the X electrodes satisfies the address facing discharge voltage Vf,xy. Conversely, after the reset discharge by the driving waveforms of the present invention (b), the cell voltage Vc,xy between the Y electrodes and the X electrodes and the cell voltage Vc,xz between the Z electrodes and the X electrodes form the wall voltages Vf,xy and Vf,xz satisfying the address facing discharge, respectively, and the cell voltage Vc,zy between the Y electrodes and the Z electrodes maintains 0V.

As described above, in the wall voltage state of the present invention, especially, after the reset discharge, the cell voltage Vc,zy maintaining 0V between the Y electrodes and the Z electrodes is sharply increased from the voltage −Vz of the third down ramp to 0V that is a ground level, and relatively maintained by the voltage −Vz of the third down ramp. Accordingly, (−) wall charges are sufficiently accumulated on the Z electrodes after the address discharge, so that the discharge operation can be stably performed in the succeeding sustain period.

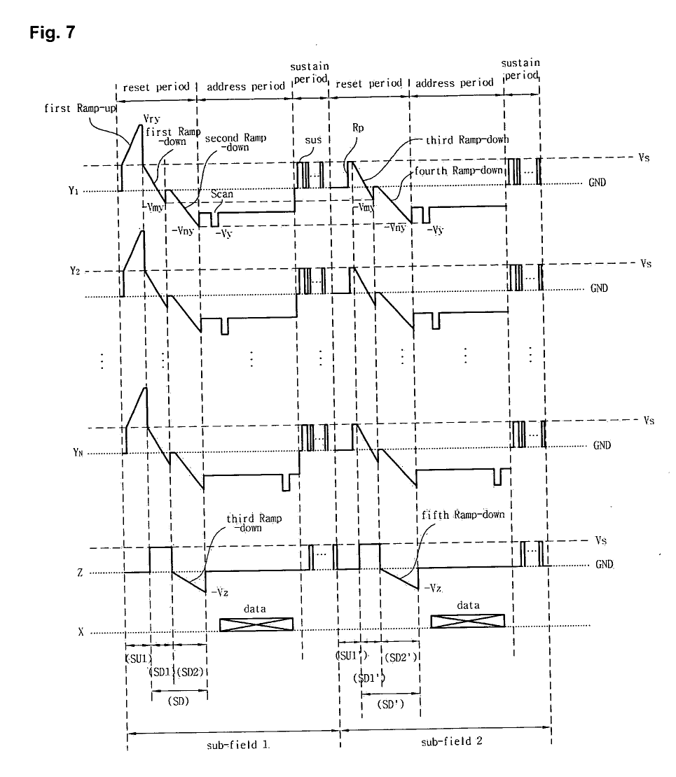

FIG. 7 is a waveform diagram showing second driving waveforms by the driving method of the plasma display apparatus in accordance with the present invention.

In the case of the second driving waveforms of the plasma display apparatus, as identical to the first driving waveforms of the present invention, different reset waveforms are supplied in the reset periods of the first sub-field and the other sub-fields. The waveforms supplied in the reset period of the first sub-field are identical to the first driving waveforms, and thus detailed explanations thereof are omitted.

The Sub-Fields Except the First Sub-Field

When the plasma display apparatus is driven, according to the driving waveforms supplied in the reset period of the other sub-fields, in the set-up period SU′, a sustain voltage positive polarity waveform Rp is applied to all the scan electrodes Y1 to Yn, and a ground level voltage is applied to the sustain electrodes Z. Here, the cells which do not participate in the discharge during the sustain period of the first sub-field are maintained as they are. In the case of the cells participating in the discharge during the sustain period of the first sub-field, surface discharge occurs between the scan electrodes Y1 to Yn and the sustain electrodes Z by the positive polarity waveform Rp, thereby partially erasing wall charges between the scan electrodes Y1 to Yn and the sustain electrodes Z.

As in the first sub-field, the set-down period SD′ is divided into a first set-down period SD1′ and a second set-down period SD2′. A fourth down ramp waveform is supplied to all the scan electrodes Y1 to Yn in the first set-down period SD1′, and a fifth down ramp waveform is supplied to all the scan electrodes Y1 to Yn in the second set-down period SD2′. While the fourth down ramp waveform is supplied to the scan electrodes Y1 to Yn, a predetermined voltage of square wave is supplied to the sustain electrodes Z, and while the fifth down ramp waveform is supplied to the scan electrodes Y1 to Yn, a sixth down ramp waveform is supplied to the sustain electrodes Z. Here, the fourth down ramp waveform and the fifth down ramp waveform are identical to the first down ramp waveform and the second down ramp waveform applied in the set-down period of the first sub-field, and the sixth down ramp waveform is identical to the third down ramp waveform. Thus, detailed explanations thereof are omitted.

On the other hand, the wall voltage state of the cells after reset discharge by the second driving waveforms of the plasma display apparatus of the present invention is substantially identical to the wall voltage state of the cells after reset discharge by the first driving waveforms, and thus detailed explanations thereof are omitted.

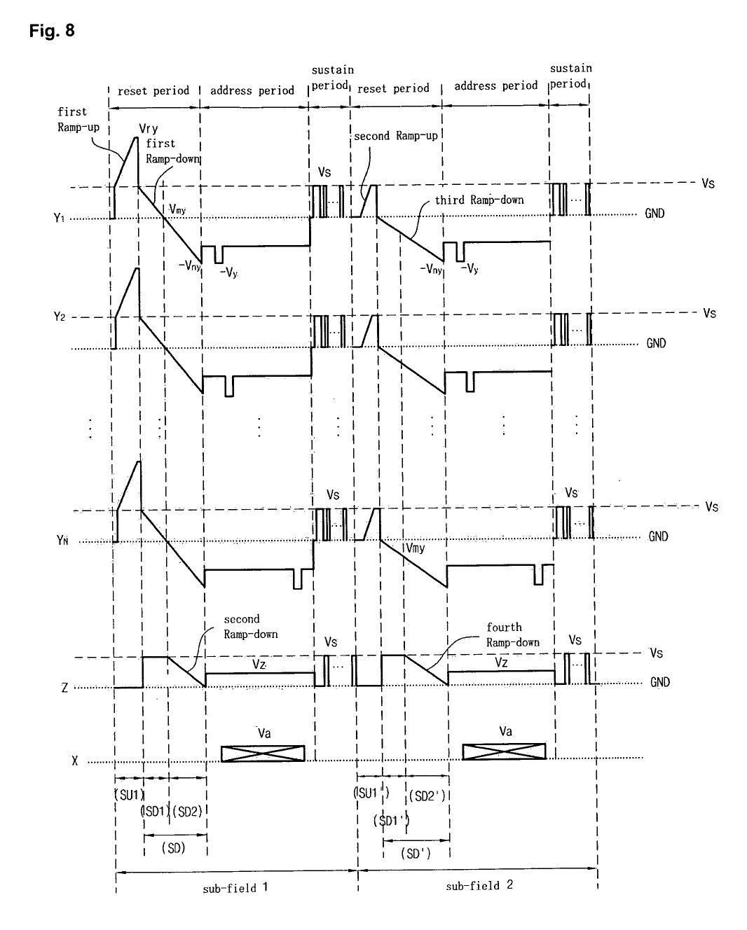

FIG. 8 is a waveform diagram showing third driving waveforms by the driving method of the plasma display apparatus in accordance with the present invention.

In the case of the third driving waveforms, as identical to the first driving waveforms, different reset waveforms are supplied in the reset periods of the first sub-field and the other sub-fields.

First Sub-Field

When the plasma display apparatus is driven, a first up ramp waveform Ramp-up is simultaneously applied to all the scan electrodes Y1 to Yn in the set-up period SU of the reset period of the first sub-field, and a ground level voltage GND is applied to the sustain electrodes Z and maintained during the set-up period SU. Here, surface discharge occurs between the scan electrodes Y1 to Yn and the sustain electrodes Z in the cells of the whole screen by the first up ramp waveform Ramp-up.

The set-down period SD is divided into a first set-down period SD1 and a second set-down period SD2. A first down ramp waveform is consecutively supplied to all the scan electrodes Y1 to Yn in the first set-down period SD1 and the second set-down period SD2. While the first down ramp waveform is supplied to the scan electrodes Y1 to Yn, a second down ramp waveform being maintained at a predetermined voltage and falling from the voltage is supplied to the sustain electrodes Z.

The first down ramp waveform supplied in the first set-down period SD1 falls from a positive polarity voltage lower than a peak voltage Vry of the first up ramp waveform to a specific voltage level −Vmy below the ground level GND. In addition, a predetermined voltage is applied to the sustain electrodes Z and maintained during the first set-down period SD1 in which the first down ramp voltage is supplied, and thus slight surface discharge occurs between the scan electrodes Y1 to Yn and the sustain electrodes Z. Accordingly, wall charges excessively formed in the cell are partially erased. Preferably, the predetermined voltage applied to the sustain electrodes Z is the sustain voltage Vs for generating surface discharge with a sufficient potential difference between the scan electrodes Y1 to Yn and the sustain electrodes Z.

The first down ramp waveform consecutively supplied in the first set-down period SD1 and the second set-down period SD2 falls to a voltage −Vny smaller than the specific voltage level −Vmy. Preferably, the lowest voltage −Vny of the first down ramp is a negative voltage for sufficiently generating facing discharge between the scan electrodes Y1 to Yn and the address electrodes X1 to Xm and completely erasing the wall charges. The second down ramp waveform falling to the ground level voltage GND is supplied to the sustain electrodes Z during the second set-down period SD2.

Therefore, the wall charges are evenly distributed in the discharge cell, so that address discharge can be stably performed in the succeeding address period.

The Sub-Fields Except the First Sub-Field

In the set-up period SU1′ of the reset period of the other sub-fields, a second up ramp waveform having a smaller voltage size than the first up ramp waveform of the first sub-field is simultaneously applied to the scan electrodes Y1 to Yn, and a ground level voltage GND is applied to the sustain electrodes Z. Accordingly, surface discharge is generated between the scan electrodes Y1 to Yn and the sustain electrodes Z in the cells of the whole screen. Here, the wall charges of the cell selected in the previous sub-field can be sufficiently erased by setting the highest voltage of the second up ramp waveform equal to or higher than the sustain voltage Vs or controlling the gradient of the second up ramp waveform.

As in the first sub-field, the set-down period SD′ is divided into a first set-down period SD1′ and a second set-down period SD2′. A third down ramp waveform is consecutively supplied to all the scan electrodes Y1 to Yn in the first set-down period SD1′ and the second set-down period SD2′, and a fourth down ramp waveform being maintained at a predetermined voltage in the first set-down period SD1′ and falling from the voltage in the second set-down period SD2′ is supplied to the sustain electrodes Z.

The third down ramp waveform falls from a ground level GND to a specific voltage level −Vny below the ground level GND in the first set-down period SD1′ and the second set-down period SD2′. The waveforms applied to the sustain electrodes Z are identical to the waveforms applied in the reset period of the first sub-field, and thus detailed explanations thereof are omitted.

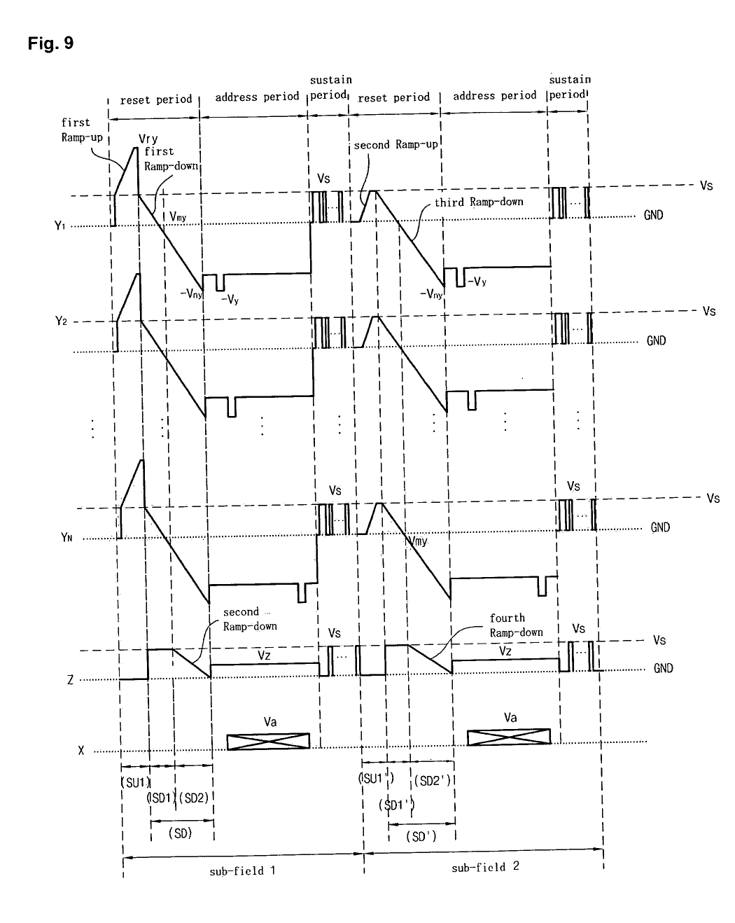

FIG. 9 is a waveform diagram showing fourth driving waveforms by the driving method of the plasma display apparatus in accordance with the present invention.

In the case of the fourth driving waveforms, as identical to the third driving waveforms, different reset waveforms are supplied in the reset periods of the first sub-field and the other sub-fields. However, the third down ramp waveform supplied in the set-down period SD′ of the reset period of the other sub-fields falls from the highest voltage of the second up ramp waveform supplied in the set-up period SU′ of the reset period to a specific voltage −Vny.

As discussed earlier, in accordance with the present invention, the up ramp waveform lower than the up ramp waveform supplied to the first sub-field is supplied to the other sub-fields, or the up ramp waveform is not at all supplied to the other sub-fields, thereby improving the contrast characteristics. Furthermore, the wall charges of the discharge cell can be uniformed before the address period, thereby improving the jitter characteristics.

The foregoing embodiment and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

What is claimed is:

1. A plasma display apparatus, comprising:
a PDP on which scan electrodes and sustain electrodes have been formed;
a scan driving unit for sequentially supplying a first up ramp waveform, a first down ramp waveform and a second down ramp waveform to the scan electrodes in a reset period of a first sub-field of a plurality of sub-fields; and
a sustain driving unit for supplying a square wave to the sustain electrodes while the first down ramp waveform is supplied to the scan electrodes, and supplying a third down ramp waveform falling from the minimum voltage of the square wave to the sustain electrodes while the second down ramp waveform is supplied to the scan electrodes.

2. The plasma display apparatus as claimed in claim 1, wherein the lowest voltages of the first down ramp waveform and the second down ramp waveform are negative voltages.

3. The plasma display apparatus as claimed in claim 2, wherein the lowest voltage of the second down ramp waveform is lower than that of the first down ramp waveform.

4. The plasma display apparatus as claimed in claim 1, wherein the maximum voltage of the square wave is a voltage of a sustain pulse applied in a sustain period.

5. The plasma display apparatus as claimed in claim 1, wherein the lowest voltage of the third down ramp waveform is a negative voltage.

6. The plasma display apparatus as claimed in claim 1, wherein the scan driving unit supplies a fourth down ramp waveform being maintained at a predetermined voltage and falling from the voltage to the scan electrodes in the reset period of the plurality of sub-fields except the first sub-field, and the sustain driving unit supplies a second up ramp waveform to the sustain electrodes while the scan electrodes are maintained at a predetermined voltage, and supplies a fifth down ramp waveform to the sustain electrodes while the fourth down ramp waveform is supplied to the scan electrodes.

7. The plasma display apparatus as claimed in claim 6, wherein the predetermined voltage is a ground level voltage.

8. The plasma display apparatus as claimed in claim 6, wherein the highest voltage of the second up ramp waveform is a sustain voltage.

9. The plasma display apparatus as claimed in claim 6, wherein the lowest voltage of the fourth down ramp waveform is identical to the lowest voltage of the second down ramp waveform.

10. The plasma display apparatus as claimed in claim 6, wherein the lowest voltage of the fifth down ramp waveform is a negative voltage.

11. The plasma display apparatus as claimed in claim 1, wherein the scan driving unit sequentially supplies a fourth down ramp waveform and a fifth down ramp waveform to the scan electrodes in the reset period of the plurality of sub-fields except the first sub-field, and the sustain driving unit supplies a square wave to the sustain electrodes while the fourth down ramp waveform is supplied to the scan electrodes, and supplies a sixth down ramp waveform falling from the minimum voltage of the square wave to the sustain electrodes while the fifth down ramp waveform is supplied to the scan electrodes.

12. The plasma display apparatus as claimed in claim 11, wherein the lowest voltage of the fourth down ramp waveform is identical to the lowest voltage of the first down ramp waveform, and the lowest voltage of the fifth down ramp waveform is identical to the lowest voltage of the second down ramp waveform.

13. The plasma display apparatus as claimed in claim 11, wherein the maximum voltage of the square wave is a voltage of a sustain pulse applied in a sustain period.

14. The plasma display apparatus as claimed in claim 11, wherein the lowest voltage of the sixth down ramp waveform is identical to the lowest voltage of the third down ramp waveform.

15. A plasma display apparatus, comprising:
a PDP on which scan electrodes and sustain electrodes have been formed;
a scan driving unit for sequentially supplying a first up ramp waveform and a first down ramp waveform to the scan electrodes in a reset period of a first sub-field of a plurality of sub-fields; and
a sustain driving unit for supplying a second down ramp waveform being maintained at a predetermined voltage and falling from the voltage to the sustain electrodes while the first down ramp waveform is supplied to the scan electrodes.

16. The plasma display apparatus as claimed in claim 15, wherein the lowest voltage of the second down ramp waveform has a ground level.

17. The plasma display apparatus as claimed in claim 15, wherein the scan driving unit sequentially supplies a second up ramp waveform and a third down ramp waveform smaller than the first up ramp waveform to the scan electrodes in the reset period of the plurality of sub-fields except the first sub-field, and the sustain driving unit supplies a fourth down ramp waveform being maintained at a predetermined voltage and falling from the voltage to the sustain electrodes while the third down ramp waveform is supplied to the scan electrodes.

18. The plasma display apparatus as claimed in claim 17, wherein the third down ramp waveform falls from a ground level.

19. The plasma display apparatus as claimed in claim 17, wherein the third down ramp waveform falls from the highest voltage of the second up ramp waveform.

20. A driving method of a plasma display apparatus, which divides a plurality of sub-fields having a different light emission number into a reset period, an address period and a sustain period, and displays an image by applying a predetermined signal to scan electrodes, sustain electrodes and address electrodes in each period, the driving method supplying one or more down ramp waveforms to the scan electrodes in the reset period of the first sub-field of the plurality of sub-fields, and supplying a waveform being maintained at a first voltage and falling to a second voltage to the sustain electrodes while the down ramp waveform is supplied to the scan electrodes.
